(19) United States
(12) Patent Application Publication
(10) Pub. No.: US 2017/0015068 A1
(43) Pub. Date: Jan. 19, 2017

(54) APPARATUS FOR PRODUCING THREE-DIMENSIONAL OBJECT

(71) Applicants: MIMAKI ENGINEERING CO., LTD., Nagano (JP); GRAPHIC CREATION Co., Ltd., Nagano (JP)

(72) Inventors: KAZUHIRO OCHI, NAGANO (JP); AKIRA IKEDA, NAGANO (JP)

(73) Assignees: MIMAKI ENGINEERING CO., LTD., NAGANO (JP); GRAPHIC CREATION Co., Ltd., NAGANO (JP)

(21) Appl. No.: 15/209,763

(22) Filed: Jul. 14, 2016

(30) Foreign Application Priority Data
Jul. 16, 2015 (JP) 2015-142480

(51) Int. Cl. B29C 67/00; B33Y 50/02; B33Y 30/00

(52) U.S. Cl. CPC B29C 67/0088; B29C 67/0059; B29C 67/0085; B33Y 30/00; B33Y 50/02; B33Y 10/00

(57) ABSTRACT

A three-dimensional object producing apparatus is provided wherein adverse impacts on three-dimensional objects due to any per-nozzle differences in discharge accuracy may be suppressible. A print device for producing a three-dimensional object includes: a head, having a plurality of nozzles; and a discharge controller, programmed to control ink discharge from the head. In this print device, the discharge controller controls the ink discharge at the time of forming a unit layer, so that a dot ink amount of the ink forming the unit layer differs between at least some of the dots.

### CROSS REFERENCE TO RELATED APPLICATIONS

This application claims the priority benefit of Japanese Patent Application No. 2015-142480, filed on Jul. 16, 2015. The entirety of the above-mentioned patent application is hereby incorporated by reference herein and made a part of this specification.

### TECHNICAL FIELD

The disclosure relates to an apparatus for producing three-dimensional objects.

### RELATED ART

Patent Document 1 describes a 3D print device including a print head having at least an array of inkjet nozzles, wherein 3D models are formed of interface materials discharged through the nozzles.

[Patent Document 1] JP 2012-71611 A (disclosed on Apr. 12, 2012)

### SUMMARY

The inkjet head typically has a large number of nozzles. The discharge accuracy may slightly differ from one nozzle to another. For example, any one of the nozzles may slightly differ in some aspects from the other nozzles. The discharge performances of the respective nozzles, though they are not necessarily be defined as inferior, may be variable, for example, failure of ink discharge in exactly the same direction, or slightly smaller or greater amounts of discharged ink than a predetermined amount. Such differences may be termed as nozzle idiosyncrasies.

In the process of producing a printed matter by stacking multiple layers on one another, as in three-dimensional objects, such nozzle idiosyncrasies may adversely affect the printed matter. For instance, in case multiple layers are formed with an ink discharged through nozzles, one of which discharges the ink slightly more or less than the other nozzles, the layers may be partly bowed inward or outward solely at a position at which the ink is discharged through the nozzle in question.

To address this issue, this disclosure provides an apparatus for producing three-dimensional objects that is operable to suppress adverse impacts on the three-dimensional objects to be produced due to any per-nozzle differences in discharge accuracy.

The inventors deliberated and worked on the issue and finally arrived at the technical solutions described below.

An apparatus for producing a three-dimensional object disclosed herein is an apparatus for producing a three-dimensional object by stacking unit layers on each other, the apparatus including: a head having a plurality of nozzles; and a discharge controller programmed to control discharge of an ink from the head. In this apparatus, the unit layers are formed with the ink discharged through the nozzles, and the discharge controller controls an ink discharge at a time of forming each one of the unit layers, so that a dot ink amount of the ink forming each one of the unit layers differs between at least a part of dots.

A method for producing a three-dimensional object disclosed herein is a method for producing a three-dimensional object by stacking unit layers on each other, the unit layers being formed with an ink discharged through a plurality of nozzles of a head. This method includes a discharge control step of controlling an ink discharge from the head, and the discharge control step includes controlling the ink discharge at a time of forming each one of the unit layers, so that a dot ink amount of the ink forming the each one of the unit layers differs between at least a part of dots.

As per these technical features, the unit layers may be respectively formed with the dots supplied in different dot ink amounts. That is to say, a difference between the dot ink amounts of the nozzles is added, as disturbance, to the per-nozzle differences in discharge accuracy. This may diminish the per-nozzle differences in discharge accuracy which is one of contributing factors possibly affecting the shape of a three-dimensional object to be produced. Then, the three-dimensional object may be less noticeably affected by the per-nozzle differences in discharge accuracy, leading to an improved accuracy in the shape of the three-dimensional object.

The three-dimensional object producing apparatus disclosed herein may preferably be further characterized in that the discharge controller selects two or more of predetermined dot ink amounts of the ink to be discharged, and the discharge controller controls the ink discharge, so that a ratio of number of dots discharged and formed in each selected one of the dot ink amounts to all of dots discharged to form each one of the unit layers differs between the one of the unit layers and another adjacent one of the unit layers in a layer-stacking direction.

According to this technical aspect, the unit layers may differ from each other in the ratio of ink dot sizes. This may allow the respective unit layers to have different degrees of surface unevenness, consequently reducing the unevenness of the uppermost surface of a large number of unit layers stacked on one another. In case the dots in an equal dot ink amount continue to be accumulated at the same position in the planar direction of the unit layers, for example, the unit layers may be partly recessed and/or grooves are possibly formed at a landing position(s) of the dots in a smaller dot ink amount. The technical aspect described earlier may suppress such unfavorable events. As a result, the unit layers may be flattened, and the three-dimensional object may be more accurately shaped.

The three-dimensional object producing apparatus disclosed herein may preferably be further characterized in that the discharge controller controls the ink discharge, so that at least one of the dots in at least one of the unit layers has a dot ink amount different from a dot at an equal position in another adjacent one of the unit layers in a layer-stacking direction.

This technical aspect may avoid accumulating the dots in an equal dot ink amount at the same position in the layer-stacking direction of one and another adjacent one of the unit layers stacked on each other. As a result, differences in height among the plural unit layers may be suppressible.

The three-dimensional object producing apparatus disclosed herein may preferably be further characterized in that the discharge controller controls the ink discharge, so that a difference between amounts of the ink per unit area of different unit layers falls within a predetermined range.

According to this technical aspect, volume variability per unit area between the unit layers may be restricted to stay within a predetermined range. As a result, the unit layers may be efficiently stacked on one another, with the dot ink amount being randomly changed. Further advantageously, this technical aspect may promote uniformity in layer thickness in processing, for example, flattening the stacked unit layers. This may afford easy handleability.

The three-dimensional object producing apparatus disclosed herein may preferably further include a nozzle inspector that inspects the nozzles. In this apparatus, the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

Thus, the dot ink amounts of other dots are controlled to be different from dot ink amounts when the nozzle currently found to be abnormal is in normal condition. This may allow the ink forming the other dots to partly spread on the dots formed by the abnormal nozzle. Then, an actual height may be approximate to a height of the dots formed when the nozzle currently found to be abnormal is in normal condition.

This disclosure may deliver the advantageous effect that adverse impacts on three-dimensional objects due to any per-nozzle differences in discharge accuracy are suppressible.

### BRIEF DESCRIPTION OF THE DRAWINGS

FIG. 1 is a schematic drawing of steps of producing a three-dimensional object M performed by a three-dimensional object producing apparatus according to an embodiment of the disclosure.

FIG. 2 is a schematic drawing of a head 1 in the three-dimensional object producing apparatus according to the embodiment.

FIGS. 3A to 3C are schematic drawings of unit layers produced by the three-dimensional object producing apparatus according to the embodiment.

FIGS. 4A to 4C are schematic drawings of unit layers produced by the three-dimensional object producing apparatus according to the embodiment.

### DETAILED DESCRIPTION OF EMBODIMENTS

<Three-Dimensional Object Producing Apparatus>

[An Embodiment of the Three-Dimensional Object Producing Apparatus of this Disclosure]

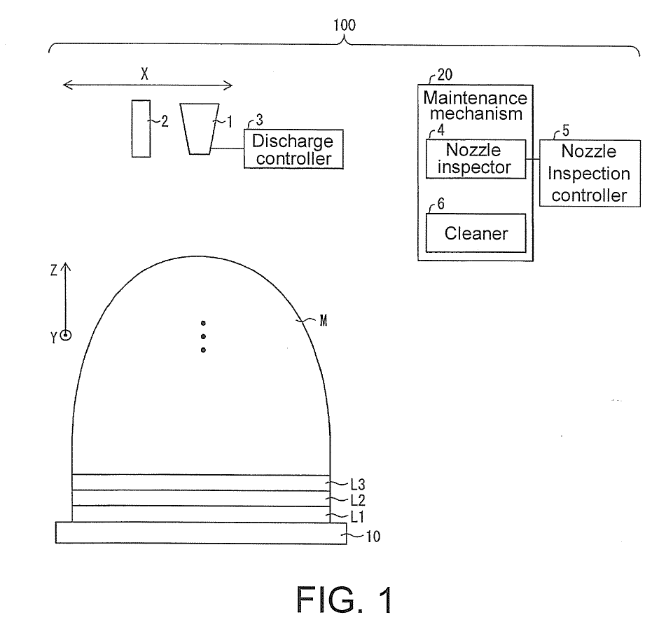

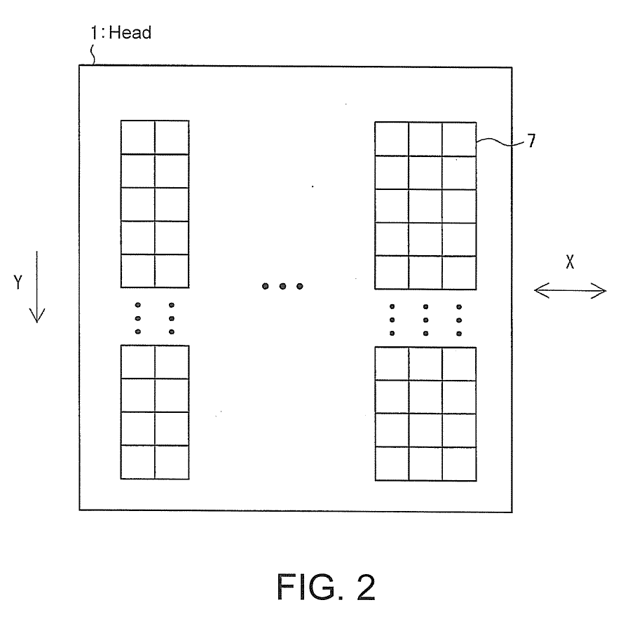

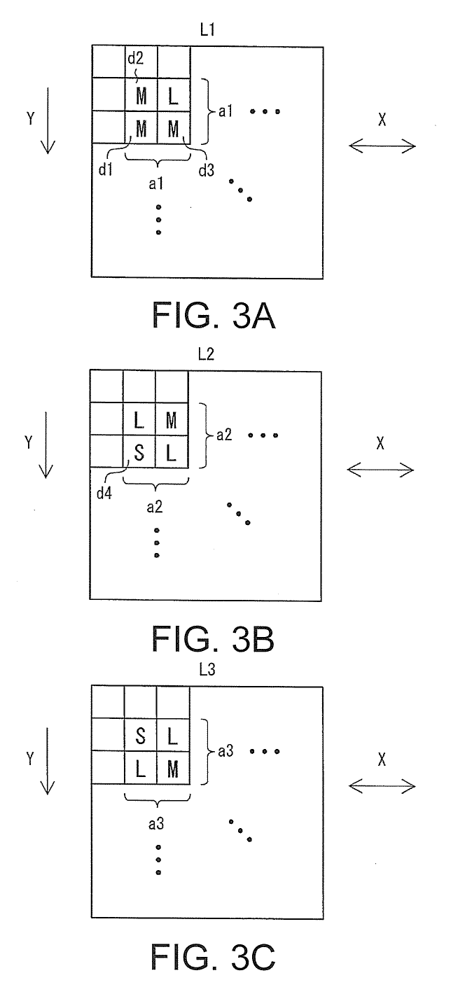

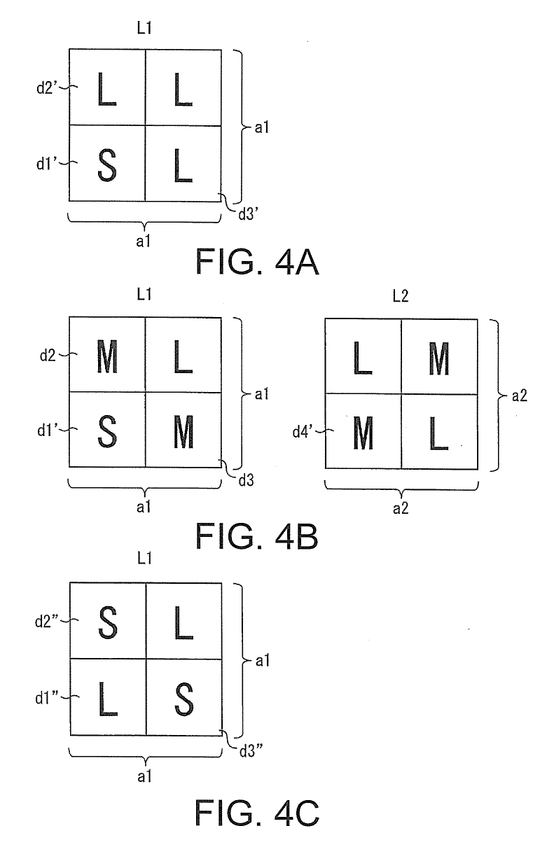

Referring to FIG. 1, FIG. 2, and FIG. 3A to FIG. 3C, an embodiment of the three-dimensional object producing apparatus disclosed herein is hereinafter described. Schematically illustrated in FIG. 1 are the structure of a print device 100 by way of example of the three-dimensional object producing apparatus, and steps of producing a three-dimensional object M performed by the print device 100. FIG. 2 is a schematic structural drawing of a head 1 in the exemplified three-dimensional object producing apparatus. FIG. 3A to FIG. 3C and FIG. 4A to FIG. 4C are schematic drawings of the configurations of unit layers L1, L2, and L3 produced by the exemplified three-dimensional object producing apparatus. FIG. 1 illustrates the three-dimensional object M in cross section cut along a plane perpendicular to the surface of a mounting table 10.

This embodiment describes producing a three-dimensional object by leveraging inkjet printing technique using an ink of ultraviolet curing type.

Specific examples of usable inks may include photo-curable inks and thermoplastic inks. The ink may preferably be selected from the photo-curable inks. Among the photo-curable inks, inks of ultraviolet curing type are particularly preferable. The inks of ultraviolet curing type are easily curable in a short time, allowing unit layers to be readily formed. Another advantage of the inks of this type is facilitating the formation of stacking ink layers, thereby achieving the production of a three-dimensional object in less time.

The inks of ultraviolet curing type may include compounds of ultraviolet curing type. The compounds of ultraviolet curing type may not necessarily be limited in so far as the compounds are cured by irradiating them with ultraviolet light. Examples of the compounds of ultraviolet curing type may include curable monomers and curable oligomers polymerized by irradiating them with ultraviolet light. Examples of the curable monomers may include low-viscosity acrylic monomers, vinyl ethers, oxetane-based monomers, and cycloaliphatic epoxy monomers. Specific examples of the curable oligomers may include acrylic oligomers.

While this embodiment uses an ink of ultraviolet curing type, inks usable in the three-dimensional object producing apparatus disclosed herein may not be limited to such inks. The three-dimensional object producing apparatus disclosed herein may optionally select one from any inks suitable for intended purposes of three-dimensional objects to be produced. For instance, any suitable one of the conventional modeling materials may be employed, or any suitable one of the conventional support materials may be employed depending on desired structures of three-dimensional objects to be produced.

As illustrated in FIG. 1, the print device 100 includes: a head 1, a UV lamp 2, a discharge controller 3, a maintenance mechanism 20, a nozzle inspection controller 5, and a mounting table 10. The maintenance mechanism 20 includes a nozzle inspector 4 and a cleaner 6.

As illustrated in FIG. 1, the three-dimensional object M is constructed of a plurality of unit layers L1, L2, L3, . . . , which are stacked in multiple layers.

(Head 1)

The head 1 is an inkjet head for ink discharge. The head 1, while reciprocating in X direction, performs scans on the mounting table 10, for example. The head 1, while performing the scans, discharges the ink on the mounting table 10 or a previously-formed unit layer to produce unit layers.

The head of the three-dimensional object producing apparatus disclosed herein may be selected from the known heads conventionally used. Specific examples of the head may include inkjet heads that discharge liquid droplets by leveraging vibrations of piezoelectric elements (inkjet heads that form liquid droplets by leveraging mechanical deformations of electrostriction elements) and inkjet heads that leverage thermal energies.

In this embodiment, a description will be given of a mode in which the head 1 is moved but a discharge target is left unmoved, during the scans performed on the mounting table 10 by the head 1 in the X direction. However, this is a non-limiting example of the three-dimensional object producing apparatus. Optionally, either one or both of the head and the discharge target may be moved relative to each other.

(Nozzle 7)

As illustrated in FIG. 2, the head 1 has nozzle arrays each having a plurality of nozzles 7 aligned along a sub scanning direction (Y direction). The ink is discharged through each of the nozzles 7. The sub scanning direction is orthogonal to the main scanning direction (X direction).

(Discharge Controller 3)

The discharge controller 3 controls the ink discharge from the head 1.

Specifically, the discharge controller 3 controls the ink discharge at the time of forming one unit layer, so that a dot ink amount of the ink forming the unit layer differs between at least some of the dots.

(UV Lamp 2)

The UV lamp 2 is an irradiator that irradiates the ink of ultraviolet curing type discharged from the head 1 with ultraviolet light.

When the ink of ultraviolet curing type is used in the three-dimensional object producing apparatus disclosed herein, however, a light irradiating device is not limited to this example and one selected from other known ultraviolet irradiating devices may be employable.

(Mounting Table 10)

The mounting table 10 is a table on which a three-dimensional object is formed and mounted.

This embodiment describes an example in which the head 1 is moved in the sub scanning direction (Y direction) with the mounting table 10 being immovably fixed. The three-dimensional object producing apparatus disclosed herein may include but is not limited to this structure in so far as the head and the discharge target are movable relative to each other. For instance, it may be the discharge target moved in the sub scantling direction (Y direction).

(Maintenance Mechanism 20)

The maintenance mechanism 20 includes a nozzle inspector 4 and a cleaner 6. The maintenance mechanism 20 is structured to house therein the head 1. Further, the maintenance mechanism 20, with the head 1 being housed therein, has the head 1 be inspected by the nozzle inspector 4 and/or be cleaned by the cleaner 6. The maintenance mechanism 20 is disposed at one end in the moving direction of the head 1 away from a scannable range of the head 1.

(Nozzle Inspector 4)

The nozzle inspector 4 is a device for inspecting the nozzles 7.

In this embodiment, “abnormal nozzle” may refer to an ink-clogged, poor-discharge nozzle. The “abnormal nozzle” includes not only non-discharge nozzles or little-discharge nozzles but also nozzles with excess ink discharge.

In the three-dimensional object producing apparatus disclosed herein, the nozzle inspector may be one selected from the known devices, for example, a photo sensor.

The inspection by the nozzle inspector 4 is controlled by the nozzle inspection controller 5. The nozzle inspection controller 5 outputs a signal indicating an instruction as to when and for which one of the nozzles 7 the inspection should be performed. The inspection is canted out based on the received instruction.

(Nozzle Inspection Controller 5)

The nozzle inspection controller 5 controls the inspection by the nozzle inspector 4. Specifically, the nozzle inspection controller 5 has the inspection-target nozzle 7 be inspected before the first time the ink is discharged through the inspection-target nozzle 7 to form a unit layer and after the underlayer of the to-be-formed unit layer is already formed.

(Cleaner 6)

The cleaner 6 is a device for cleaning the nozzles 7. The cleaner 6 includes a wiper for wiping a surface of the head 1 having the nozzles 7 formed thereon, a suction device for suctioning the ink out of the nozzles 7, and a purging mechanism.

[Method for Producing Three-Dimensional Object M Using Print Device 100]

A method for producing the three-dimensional object M using the print device 100 is hereinafter described.

The description starts with the production method of the unit layer L1 illustrated in FIG. 1.

The ink is discharged from the head 1 during scans performed by the head 1 in the X direction. When the head 1 is moving, the UV lamp 2 in proximity of the head 1 moves similarly to the head 1. Usable examples of the UV lamp 2 may include metal halide lamps and LED lamps.

The ink discharged from the head 1 is irradiated with ultraviolet light emitted from the UV lamp 2 and thereby starts to be cured.

Next, the head 1 is moved in the Y direction in each scan performed by the head 1.

The moving distance of the head 1 is equal to the length of an ink discharge region (nozzle array) of the head 1 in the sub scanning direction (Y direction). Thus, this embodiment describes the single-pass printing technique. The single-pass printing technique forms each unit image region (printing region per unit length square) in one main scan. This disclosure includes but is not limited to the single-pass printing technique. The multi-pass printing technique may be employable. In that case, a distance by which the head is moved once in the sub scanning direction (Y direction) is shorter than the length of the ink discharge region of the head (nozzle array) in the sub scanning direction (Y direction). Therefore, printing each unit image region requires plural main scans.

The discharge controller 3 controls the head 1 to have the ink be discharged in a dot ink amount selected from three predetermined measures to form the unit layer L1. Symbols “S”, “M”, and “L” refer to the smaller to greater three measures of the dot ink amounts. In order to avoid that all of the unit layers are formed with the ink in an equal dot ink amount, the discharge controller 3 controls the head 1 so that at least one of S, M, and L is included in each one of the unit layers.

Supposing that one of the nozzles 7 has certain idiosyncrasies in its discharge amount and discharge direction unique to this nozzle as compared to the other nozzles, controlling the head 1 in the described manner may suppress adverse impacts due to such idiosyncrasies on the shape and possibly other aspects of the three-dimensional object M. Differences among the dot ink amounts of the nozzles 7 are added, as disturbance, to differences in discharge accuracy among the nozzles 7. Then, the three-dimensional object M may be less noticeably affected by the differences in discharge accuracy among the nozzles 7, leading to an improved accuracy in the shape of this three-dimensional object.

This may successfully suppress adverse impacts due to the idiosyncrasies that differ from one nozzle 7 to another. Additionally, the printing result may be less likely to be affected by poor discharge performances including insufficient discharge amount and ink landing failure.

Specifically, the discharge controller 3 reads information of the S, M, and L dot ink amounts stored in a recording unit (not illustrated in the drawings), calculates when and from which nozzle the ink in the S, M, or L dot ink amount should be discharged, and then accordingly controls the head 1.

The calculation is more specifically to calculate ratios of number of dots in the S, M, and L dot ink amounts to all of dots based on a total ink amount required to form one unit layer, so that the dots in different dot ink amounts are randomly allocated in the unit layer. To this end, a mathematical function may be provided, in which the S, M, and L dot numbers are defined so as to have a total ink amount per unit area be constant at all times, and one or two of the S, M, and L dot numbers are changed to the other dot numbers in each one of the unit layers. This may allow the S, M, and L dot numbers to be randomly set in different unit layers. In this connection, a total ink amount required to print the three-dimensional object M may be calculated from image information (for example, volume) of this object separately provided, and a total ink amount for one unit layer to be formed may be figured out from the calculated total ink amount.

This embodiment describes three measures (S, M, L) by way of example of dot sizes. This disclosure is not necessarily limited to this example in so far as the dot ink amount of the ink forming each one of the unit layers differs between at least some of the dots.

The discharge controller 3 controls the ink discharge so that the largest dot ink amount L accounts for percentages equal to or greater than 80% of all of the ink dots forming the unit layer L1. By thus controlling the ink discharge, the unit layer L1 may be more efficiently formed because its most part is formed with the dots in the largest dot ink amount. This embodiment provides for three measures of ink dots, which is, however, a non-limiting example. Preferably, this disclosure may provide for two or more dot ink amounts and 15 or less dot ink amounts. More preferably, this disclosure may provide for three or more dot ink amounts and seven or less dot ink amounts. With three or more dot ink amounts, when the ratio of number of dots in one dot ink amount is changed, the ratios of number of dots in the other two dot ink amounts may be accordingly adjustable. Then, the ratios of dot numbers in the respective dot ink amounts may be changeable, while the ink total amount per unit area of each unit layer remains unchanged. A broader variety of dot ink amounts may be more advantageous, which, however, proportionately increases the amount of information used for signals to select the measures of dot ink amounts (fluid measures). Therefore, seven or less dot ink amounts may preferably be used. The generally called, levels of grayscale, for designating the measures of dot ink amounts (fluid measures), are uniquely decided depending on a head used as the head 1. Therefore, the head 1 may preferably be a head having three or more levels of grayscale.

By prompting the head 1 to perform the scans in the X direction while moving in the Y direction, the unit layer L1 is formed.

Then, the unit layer L2 and the unit layer L3 are successively formed.

As for the unit layer L2, the discharge controller 3 controls the ink discharge so that the ratios of dot numbers in the dot ink amounts S, M, and L to all of the ink dots forming the unit layer L2 differ from the ratios in the unit layer L1. As for the unit layer L3, the discharge controller 3 controls the ink discharge so that the ratios of dot numbers in the dot ink amounts S, M, and L to all of the ink dots forming the unit layer L3 differ from the ratios in the unit layer L2. At the time of forming the unit layer L3, the ratios of S, M, and L dot numbers are arranged to differ from the ratios in the unit layer L1 as well. This may allow the unit layer L2 to have the ratios that differ from both of the adjacent unit layers in the layer-stacking direction.

The ratios of number of dots in the dot ink amounts S, M, and L forming the unit layers are calculated so that the dots in different dot ink amounts are randomly allocated in the respective unit layers. Accordingly, the ratios of the measures of the dot ink amounts may randomly differ between vertically adjacent ones of the unit layers, and positions of contact between the dots and distribution of the dot ink amounts may also differ between the adjacent unit layers. Therefore, the stacked unit layers may avoid markedly noticeable unevenness or the formation of grooves. As a result, the unit layers may be flattened, and the three-dimensional object M may be more accurately shaped. To calculate the above-described ratios, software may be used, which is, for example, designed to calculate printing-required information from image information of the three-dimensional object M.

In this disclosure, the discharge controller may control the ink discharge so that the ratio of number of dots discharged and formed in each selected one of the dot ink amounts to all of dots discharged to form one unit layer is different between or the same in the adjacent unit layers in the layer-stacking direction. However, the ratios may preferably differ between the adjacent layers to achieve a higher shape accuracy of the object.

In this embodiment, the discharge controller controls the ink discharge so that, in all of the unit layers, the ratio of number of dots discharged and formed in each selected one of the dot ink amounts to all of dots discharged to form one unit layer differs between one of the unit layers and another adjacent one of the unit layers in the layer-stacking direction. This disclosure, however, is not necessarily limited thereto. This disclosure may be effective in so far as the ratios differ in at least one of the unit layers.

As illustrated in FIG. 3A to FIG. 3C, the dot ink amounts in the adjacent unit layers in the layer-stacking direction may preferably be as different as possible from each other. By preventing the dots in an equal dot ink amount from being accumulated in the layer-stacking direction, differences in height among the plural unit layers may be suppressible.

In this embodiment, the dot ink amounts in the adjacent unit layers in the layer-stacking direction may preferably be as different as possible from each other in all of the unit layers. This disclosure, however, is not necessarily limited thereto. Optionally, the dot ink amounts in the adjacent layers in the layer-stacking direction may be equal in all of the unit layers. To minimize differences in height among the plural unit layers, however, the dot ink amounts in the adjacent layers in the layer-stacking direction may preferably differ between the adjacent unit layers. In this connection, this disclosure may be effective in so far as at least one of the dot ink amounts in at least one of the unit layers is different from the dot ink amount in the adjacent unit layer in the layer-stacking direction.

The discharge controller 3 controls the ink discharge so that ink amounts in the unit layers L1, L2, and L3 per unit area are equal. For instance, S is 10 pl, M is 20 pl, and L is 30 pl, and a1×a1, a2×a2, and a3×a3 are simply the respective unit areas. Then, these unit layers have an equal volume within their unit areas. Therefore, the unit layers L1, L2, L3, and the like may be efficiently stacked on one another, with the dot ink amount being randomly changed to and from S, M, and L. Further advantageously, this technical aspect may promote uniformity in layer thickness in processing, for example, flattening the stacked unit layers. This may afford easy handleability.

The volumes per unit area may preferably be equal as described in this embodiment. However, slight differences in volume may be acceptable. By regulating the differences to stay within a predetermined range, the unit layers may be efficiently stacked and later processed, for example, flattened.

By forming the unit layers L1, L2, and L3 and stacking them in the Z direction as illustrated in the drawing, the three-dimensional object M may be finally obtained.

The “unit area” in this description refers to an area calculated by predetermined distance×predetermined distance, for example, 1 mm×1 mm, 1 cm×1 cm, or length of aligned dots×length of aligned dots.

[Methods for Suppressing Adverse Impacts by Abnormal Nozzle]

Next, a description will be given of methods for producing the three-dimensional object M while suppressing adverse impacts by any one of the nozzles 7 found to be abnormal.

Before the printing operation starts, the head 1 is housed in the maintenance mechanism 20.

The nozzle inspection controller 5, upon recognizing the start of the printing operation, identifies the nozzles 7 to be used for the formation of the unit layer L1. For instance, the nozzle inspection controller 5 may generate, from image data of the three-dimensional object M, data indicative of which ones of the nozzles 7 are used and when the selected nozzles 7 should be used to discharge the ink, or the nozzle inspection controller 5 may obtain data generated by a hardware component in which another printing software is installed and thereby identify any ones of the nozzles 7 to be used for the formation of the unit layer L1.

The nozzle inspection controller 5 recognizes the start of the printing operation as described below. A user inputs an instruction to start the production to an input unit (not illustrated in the drawing). The nozzle inspection controller 5, upon receipt of the instruction, recognizes the start of the printing operation. In case a single instruction requests the production of different three-dimensional objects, the nozzle inspection controller 5 may be programmed to recognize a timing of switching to a next one of the three-dimensional objects as the start of the printing operation.

The nozzle inspection controller 5 outputs an instruction to the nozzle inspector 4 to request the inspection of the nozzles 7 used to form the unit layer L1.

The nozzle inspector 4 inspects the nozzles 7 to be inspected based on the instruction from the nozzle inspection controller 5. Specifically, the ink discharge may be determined by detecting whether light is blocked using a light sensor. The nozzle inspector 4 outputs an obtained measurement result to the nozzle inspection controller 5. The nozzle inspection controller 5 identifies, within a predetermined time frame, any one of the nozzles 7 whose discharge amount exceeds a predetermined amount by a predetermined allowable range. The predetermined time frame, predetermined amount, and predetermined allowable range are stored in a recording unit (not illustrated in the drawing). The nozzle inspection controller 5 reads, from the recording unit, the time and amount-related information and uses the read information to determine whether the inspected nozzle(s) is abnormal.

In this embodiment, any ones of the nozzles used for the first time to form a unit layer alone are to be inspected. The inspection of nozzles described in this embodiment, though not necessarily limited thereto, is suitable for the production of three-dimensional objects.

The nozzles are prone to have trouble with discharge performance as they are left unused over a long period of time. The materials used to produce a three-dimensional object may significantly differ in frequency of use, depending on whether they are model materials or support materials, or white, color, or clear inks. Supposing that all of the nozzles have been inspected before the operation starts, some of the nozzles may still develop some kind of trouble if left unused over time. This embodiment, however, may allow for efficient detection of such nozzle trouble.

In case any one of the nozzles 7 is found to be abnormal, information indicative of which one of the nozzles 7 is abnormal is outputted to the discharge controller 3. The discharge controller 3 starts to form the unit layer L1, with an effort to minimize adverse impacts by the abnormal nozzle(s) 7. In this embodiment, adverse impacts by the abnormal nozzle may be specifically suppressed as described below.

[Method 1 for Suppressing Adverse Impacts by Abnormal Nozzle]

The description starts with an example in which the discharge amount of the abnormal nozzle is insufficiently small. In this example, a dot d1′ is formed with the ink in the small dot ink amount S, where a dot d1 should have originally been formed with the ink in the dot ink amount M, as illustrated in FIG. 4A.

In this instance, the dot ink amount is increased for a dot d2 adjacent to the dot d1′ in the negative direction of the sub scanning direction (−Y direction) and a dot d3 adjacent to the dot d1′ in the main scanning direction (X direction), as illustrated in FIG. 4A.

In case the nozzle 7 that discharged the ink of the dot d1′ is not abnormal, a dot d2′ is formed with the ink in the dot ink amount L, where the dot d2 should have originally been formed with the ink in the dot ink amount M.

In case the nozzle 7 that discharged the ink of the dot d1′ is not abnormal, a dot d3′ is formed with the ink in the dot ink amount L, where the dot d3 should have originally been formed with the ink in the dot ink amount M.

This may allow the ink forming the dots d2′ and d3′ to partly spread on the dot d1′. As a result, the height of a1×a1 may be higher than otherwise. Thus, an actual height may be approximate to the height of a1×a1 when the nozzle that discharged the ink forming the dot d1′ is not abnormal.

To address the issue of an insufficiently small discharge amount of the abnormal nozzle, this example increases the amounts of ink discharged through the nozzles forming the adjacent dots, thereby suppressing the adverse impacts.

This disclosure is not necessarily limited to this example. This disclosure is not meant to address the issue of discharge-insufficient abnormal nozzles alone. This embodiment includes changing the dot ink amount of the ink discharged through the nozzle that forms at least a part of other dots within a predetermined extent from the dots formed by the abnormal nozzle.

As described in this example, the dot ink amounts in the adjacent unit layers may be changed. Alternatively, the dot ink amounts in the unit layers within certain proximity may be changed in addition to the dot ink amounts in the adjacent unit layers. The certain proximity may refer to a region in the planar direction or the layer-stacking direction of the unit layers.

[Method 2 for Suppressing Adverse Impacts by Abnormal Nozzle]

In this example, the dot d1′ is formed with the ink in the small dot ink amount S, where the dot d1 should have originally been formed with the ink in the dot ink amount M, as illustrated in FIG. 4B.

The unit layer L1 is formed without any change of the dot ink amounts of the dots d2 and d3 from dot ink amounts when the nozzle that discharges the ink forming the dot d1′ is not abnormal.

In the process of forming the unit layer L2, a dot d4 adjacent to the dot d1′ in the layer-stacking direction is formed with the ink in the dot ink amount M larger than S originally planned for this dot.

Accordingly, heights at positions at which the dots d1′ and d4′ are formed when the formation of the unit layers L1 and L2 is completed may be equal to heights at the same positions when the nozzle that discharges the ink forming the dot d1′ is not abnormal.

[Method 3 for Suppressing Adverse Impacts by Abnormal Nozzle]

In this example, a dot d1″ is formed with the ink in the dot ink amount L, where the dot d1 should have originally been formed with the ink in the dot ink amount M, as illustrated in FIG. 4C.

In this instance, the dot ink amount is decreased for the dot d2 adjacent to the dot d1″ in the negative direction of the sub scanning direction (−Y direction) and the dot d3 adjacent to the dot d1″ in the main scanning direction (X direction), as illustrated in FIG. 4C.

In case the nozzle 7 that discharged the ink of the dot d1″ is not abnormal, a dot d2″ is formed with the ink in the dot ink amount S, where the dot d2 should have originally been formed with the ink in the dot ink amount M.

In case the nozzle 7 that discharged the ink of the dot d1′ is not abnormal, a dot d3″ is formed with the ink in the dot ink amount S, where the dot d3 should have originally been formed with the ink in the dot ink amount M.

This may allow the ink forming the dot d1″ to partly spread on the dots d2″ and d3″. As a result, the height of a1×a1 may be higher than otherwise. Thus, an actual height may be approximate to the height of a1×a1 when the nozzle that discharged the ink forming the dot d1′ is not abnormal.

The ink discharge control of Methods 1 to 3 described so far are carried out by the discharge controller 3. Stored in the recording unit (not illustrated) are programs designed for these control processes. The discharge controller 3 carries out the processes based on the programs. A user may decide which one of the exemplified control processes should be selected, or the discharge controller 3 may select any suitable one of them based on the specific condition of the abnormal nozzle or dot ink amounts of other dots beyond the illustrated range.

[Other Methods for Suppressing Adverse Impacts by Abnormal Nozzle]

Optionally, any other suitable method for suppressing adverse impacts by abnormal nozzle may be jointly employed.

For instance, number of scans to be performed to form the image of a unit region may be increased to perform the multi-pass printing. This may also suppress adverse impacts resulting from any abnormal nozzle.

Alternatively, the nozzles 7 may be cleaned by the cleaner 6. In case any nozzle is found to be abnormal by the inspection conducted after the unit layer L1 is formed, any one of the adverse impact suppressing methods described earlier may preferably be employed to shorten the production time. This is suggested because cleaning the nozzles 7 in every inspection thereafter may prolong the production time.

[Production of Unit Layers Subsequent to Unit Layer L2]

The unit layer L1 is thus formed with the described effort to minimize adverse impacts by the abnormal nozzle. After the unit layer L1 is formed, the nozzle inspection controller 5 inspects any ones of the nozzles 7 unused for the unit layer L1 but used to form the unit layer L2. The nozzles 7 to be inspected are more specifically the ones unused for the unit layer L1 but used to form the unit layer L2 for the first time after the production of the three-dimensional object M started. Which ones of the nozzles 7 are to be inspected may be known from data indicative of which ones of the nozzles 7 is used and when the selected nozzles 7 should be used.

The unit layer L2 is then formed. Unless stated otherwise, the production of the unit layer L2 and subsequent layers is carried out as described in [Method for producing three-dimensional object M using print device 100].

The nozzle inspection controller 5 inspects any ones of the nozzles 7 unused by then for the unit layer L1 or L2 but used for the first time to form the unit layer L3.

The unit layer L3 is then formed.

As the unit layers are formed, they are stacked on one another in the Z direction. From then on, the nozzles 7 to be inspected are the ones unused by then for ink discharge to form any unit layers but ready to discharge the ink to form a next unit layer for the first time after the production of the three-dimensional object M started.

[Software-Configured Example]

The control block including the discharge controller 3 and the nozzle inspection controller 5 may be configured with a logic circuit (hardware) formed in, for example, a semiconductor circuit (IC chip), or CPU (Central Processing Unit)-controlled software.

In the latter example, the discharge controller 3 and the nozzle inspection controller 5 may be equipped with CPU operable to execute commands from software programs designed for implementing their functions, ROM (Read Only Memory) or recording devices in which the programs and various data are stored and readable by a computer (or CPU) (collectively referred to as “recording media), and RAM (Random Access Memory) in which the programs are accessed and run. The functions of this disclosure may be accomplished by prompting the computer (or CPU) to read the programs from the recording media and execute them. Examples of the recording media may include “non-transitory, tangible media”, such as tapes, discs, cards, semiconductor memories, and programmable logic circuits. The programs may be installed in the computer via an optional transmission medium (communication network, broadcast wave, etc.) through which the programs are transmittable. This disclosure may be implemented by using data signals embedded in carrier wave by way of electronic transmission of the programs.

(Additional Remarks)

The three-dimensional object producing apparatus according to the embodiment of the disclosure is a print device 100 for producing a three-dimensional object M by stacking unit layers L1, L2, L3, and the like on one another. The print device 100 includes: a head 1 having a plurality of nozzles 7; and a discharge controller 3 programmed to control ink discharge from the head 1. In this device, the unit layers are formed with an ink discharged through the nozzles 7, and the discharge controller 3 controls the ink discharge at the time of forming each one of the unit layers so that the dot ink amounts S, M, and L of the ink forming the unit layer are selected differently between at least some of the dots.

The three-dimensional object producing method according to an embodiment of the disclosure is a method for producing a three-dimensional object M by stacking unit layers L1, L2, L3, and the like on one another. In this method, the unit layers L1, L2, L3, and the like are formed with an ink discharged through a plurality of nozzles 7 of a head 1. The method includes a discharge control step of controlling the ink discharge from the head 1, and the discharge control step includes controlling the ink discharge at the time of forming each one of the unit layers so that the dot ink amounts S, M, and L of the ink forming the unit layer are selected differently.

As per these technical features, each unit layer is formed of the ink dots supplied in the different dot ink amounts S, M, and L. That is to say, differences among the dot ink amounts S, M, and L of the nozzles 7 are added, as disturbance, to differences in discharge accuracy among the nozzles 7. This may diminish the differences in discharge accuracy among the nozzles 7 which is one of contributing factors that affect the shape of the three-dimensional object M to be produced. Then, the three-dimensional object M may be less noticeably affected by the differences in discharge accuracy among the nozzles 7, leading to an improved accuracy in the shape of the three-dimensional object M.

The three-dimensional object producing apparatus may be further characterized in that the discharge controller 3 selects two or more of dot ink amounts S, M, and L of the ink to be discharged, and the discharge controller 3 controls the ink discharge so that the ratio of number of dots discharged and formed in each selected one of the dot ink amounts S, M, and L to all of dots discharged to form each one of the unit layers differ between the one of the unit layers and another adjacent one of the unit layers in the layer-stacking direction.

According to this technical aspect, the unit layers may differ from one another in the ratio of ink dot sizes. This may allow the respective unit layers to have different degrees of surface unevenness, consequently reducing the unevenness of the uppermost surface of a large number of unit layers L1, L2, L3, . . . , stacked on one another. In case the dots in an equal dot ink amounts continue to be accumulated at the same position in the planar direction of the unit layers, for example, the unit layers may be partly recessed and/or grooves are possibly formed at a landing position(s) of the dots in the smaller dot ink amount S. The three-dimensional object producing apparatus may suppress such unfavorable events. As a result, the unit layers may be flattened, and the three-dimensional object M may be more accurately shaped.

The three-dimensional object producing apparatus may be further characterized in that the discharge controller 3 controls the ink discharge so that one of the dots in each of the unit layers is discharged in a dot ink amount different from a dot at an equal position in another adjacent one of the unit layers in the layer-stacking direction.

This technical aspect may avoid accumulating the dots in an equal dot ink amount at the same position in the layer-stacking direction of one and another one of the unit layers stacked on each other. As a result, differences in height among the plural unit layers may be suppressible.

The three-dimensional object producing apparatus may be further characterized in that the discharge controller 3 controls the ink discharge so that the amounts of ink per unit areas a1×a1, a2×a2, and a3×a3 in different unit layers are equal.

Therefore, the unit layers L1, L2, L3, and the like may be efficiently stacked on one another, with the dot ink amount being randomly changed to and from S, M, and L. Further advantageously, this technical aspect may promote uniformity in layer thickness in processing, for example, flattening the stacked unit layers. This may afford easy handleability.

The three-dimensional object producing apparatus may further include a nozzle inspector 4 for inspecting the nozzles. In this apparatus, the discharge controller 3 controls the ink discharge so that an amount of ink discharged through the nozzles 7 that form at least a part of the dots d2, d3, d4, and the like adjacent to the dots d1′, d1″, and the like formed by any one of the nozzles inspected and found to be abnormal by the nozzle inspector 4 differs from an amount of ink when the nozzle currently abnormal is not found to be abnormal.

Thus, the dot ink amounts of the adjacent dots d2, d3, d4, and the like are controlled to be different from dot ink amounts when the abnormal nozzle is not found to be abnormal. This may allow the ink forming the adjacent dots d2′, d2″, d3′, d3″, d4′, and the like to partly spread on the dots d1′, d1″, and the like formed by the abnormal nozzle. Then, an actual height may be approximate to a height of the dot d1 or the like formed when the nozzle currently abnormal is not found to be abnormal.

### INDUSTRIAL APPLICABILITY

This disclosure may be advantageously applicable to the production of three-dimensional objects.

What is claimed is:

1. An apparatus for producing a three-dimensional object by stacking unit layers on each other, the apparatus comprising:
a head having a plurality of nozzles; and
a discharge controller to control discharge of an ink from the head, wherein
the unit layers are formed with the ink discharged through the nozzles, and
the discharge controller controls an ink discharge at a time of forming each one of the unit layers, so that a dot ink amount of the ink forming each one of the unit layers differs between at least a part of dots.

2. The apparatus for producing a three-dimensional object according to claim 1, wherein
the discharge controller selects two or more than two of predetermined dot ink amounts of the ink to be discharged, and
the discharge controller controls the ink discharge, so that a ratio of number of dots discharged and formed in each selected one of the dot ink amounts to all of dots discharged to form each one of the unit layers differs between the one of the unit layers and another adjacent one of the unit layers in a layer-stacking direction.

3. The apparatus for producing a three-dimensional object according to claim 1, wherein
the discharge controller controls the ink discharge, so that at least one of the dots in at least one of the unit layers is discharged in a dot ink amount different from a dot at an equal position in another adjacent one of the unit layers in a layer-stacking direction.

4. The apparatus for producing a three-dimensional object according to claim 2, wherein
the discharge controller controls the ink discharge, so that at least one of the dots in at least one of the unit layers is discharged in a dot ink amount different from a dot at an equal position in another adjacent one of the unit layers in a layer-stacking direction.

5. The apparatus for producing a three-dimensional object according to claim 1, wherein
the discharge controller controls the ink discharge, so that a difference between amounts of the ink per unit area of different unit layers falls within a predetermined range.

6. The apparatus for producing a three-dimensional object according to claim 2, wherein
the discharge controller controls the ink discharge, so that a difference between amounts of the ink per unit area of different unit layers falls within a predetermined range.

7. The apparatus for producing a three-dimensional object according to claim 3, wherein
the discharge controller controls the ink discharge, so that a difference between amounts of the ink per unit area of different unit layers falls within a predetermined range.

8. The apparatus for producing a three-dimensional object according to claim 4, wherein
the discharge controller controls the ink discharge, so that a difference between amounts of the ink per unit area of different unit layers falls within a predetermined range.

9. The apparatus for producing a three-dimensional object according to claim 1, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

10. The apparatus for producing a three-dimensional object according to claim 2, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

11. The apparatus for producing a three-dimensional object according to claim 3, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

12. The apparatus for producing a three-dimensional object according to claim 4, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

13. The apparatus for producing a three-dimensional object according to claim 5, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

14. The apparatus for producing a three-dimensional object according to claim 6, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

15. The apparatus for producing a three-dimensional object according to claim 7, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

16. The apparatus for producing a three-dimensional object according to claim 8, further comprising:
a nozzle inspector that inspects the nozzles,
wherein the discharge controller controls the ink discharge, so that an amount of ink discharged through the nozzle that forms at least a part of other dots within a predetermined extent from dots formed by any one of the nozzles inspected and found to be abnormal by the nozzle inspector differs from an amount of ink when the nozzle currently abnormal is not found to be abnormal.

17. A method for producing a three-dimensional object by stacking unit layers on each other, the unit layers being formed with an ink discharged through a plurality of nozzles of a head, wherein the method comprises:
a discharge control step of controlling an ink discharge from the head, and
the discharge control step includes: controlling the ink discharge at a time of forming each one of the unit layers, so that a dot ink amount of the ink forming each one of the unit layers differs between at least a part of dots.
